(19) United States
(12) Patent Application Publication
(10) Pub. No.: US 2026/0175414 A1
(43) Pub. Date: Jun. 25, 2026

(54) METHODS AND SYSTEMS FOR ROBOT KEYFRAMING AND LEARNING LOCOMOTION WITH HIGH-LEVEL OBJECTIVES

(71) Applicants: DISNEY ENTERPRISES, INC., Burbank, CA (US); ETH Zürich, Zürich (CH)

(72) Inventors: Fatemeh Zargarbashi, Zürich (CH); Robert Walker Sumner, Zürich (CH); Jin Cheng, Zürich (CH); Dong Ho Kang, Zürich (CH); Stelian Coros, Zürich (CH)

(21) Appl. No.: 18/987,102

(22) Filed: Dec. 19, 2024

(51) Int. Cl. B25J 9/16; G05B 13/02

(52) U.S. Cl. CPC B25J 9/163; G05B 13/0265

(57) ABSTRACT

Methods and systems for animated figure keyframing or physical robot keyframing and learning locomotion with high-level objectives are discussed herein. For example, generating motion for an animated figure may include generating a control policy for the animated figure using a reinforcement learning model, wherein the control policy is configured to control a movement of the animated figure to achieve one or more keyframes. Generating motion for the animated figure may further include encoding the control policy onto a processor of the animated figure. In some cases, the control policy for the animated figure may be generated using a multi-input single-output transformer encoder. Generating motion for the animated figure further includes determining one or more target keyframes and generating, using the control policy, the motion for the animated figure based on the one or more target keyframes.

### FIELD

The present disclosure relates generally to systems and methods for generating motion for an animated figure.

### BACKGROUND

Amusement parks, theme parks, carnivals, arcades, and various attractions use animated figures to produce an interactive effect for guests in entertainment experiences. For example, in rides, shows, games, etc. animated figures mimic the movement, look, and emotion of characters in the experience.

Additionally, reinforcement learning has been increasingly applied to develop locomotion policies for, for example, four-legged or two-legged animated figures (e.g., robots and animatronics). The primary focus has been to achieve robust control policies that can accurately track velocity commands from joysticks. More recently, researchers have attempted to enhance the versatility of legged robot controllers by incorporating high-level objectives, particularly through position- or orientation-based targets. This high-level control is typically accomplished through hierarchical frameworks, where a high-level policy is learned to drive a low-level controller. Conversely, end-to-end approaches aim to develop a unified policy for both high- and low-level control, allowing high-level objectives to directly influence low-level decisions. However, the current implementations of reinforcement learning urge the animated figure to reach a target as fast as possible, lacking refined control of the timing for achieving the target.

Current animated figures trained by current reinforcement learning models are deficient in numerous ways. For example, movements performed by animated figures are choppy, unnatural, and may be hard to direct at a high-level by a non-expert user. As a result, the animated figures stand out in their environments, may be off-putting, and cannot achieve goals or movements.

### SUMMARY

In one embodiment, a method of generating motion for an animated figure includes: generating a control policy for the animated figure using a reinforcement learning model, wherein the control policy is configured to control a movement of the animated figure to achieve one or more keyframes; encoding the control policy onto a processor of the animated figure; receiving one or more target keyframes; and generating, using the control policy, the motion for the animated figure based on the one or more target keyframes.

Optionally, in some embodiments, the reinforcement learning model includes a multi-critic reinforcement learning model.

Optionally, in some embodiments, the multi-critic reinforcement learning model includes one or more dense rewards and one or more sparse rewards.

Optionally, in some embodiments, method further includes training the multi-critic reinforcement learning model using the one or more dense rewards and the one or more sparse rewards, wherein the one or more dense rewards are normalized independently from the one or more sparse rewards.

Optionally, in some embodiments, the one or more dense rewards correspond to instantaneous movement of the control policy.

Optionally, in some embodiments, the one or more sparse rewards correspond to whether the generated motion correctly corresponds to the one or more target keyframes.

Optionally, in some embodiments, the reinforcement learning model includes one or more regularization critics and wherein the one or more regularization critics include one or more of: an acceleration value, an animated figure joint limit value, an animated figure velocity limit value, a jerking motion value, and a torque value.

Optionally, in some embodiments, the reinforcement learning model includes one or more style critics and wherein the one or more style critics include one or more of: a discriminator reward estimate, a natural motion reward, and reference motion corresponding to animal motions, human motions or animated motions.

Optionally, in some embodiments, generating the control policy is further based on using a multi-input single-output transformer encoder.

In one embodiment, an animated figure includes: at least one actuator: a processing element; a memory component, wherein the memory component stores a control policy trained based on one or more sparse rewards and one or more dense rewards, wherein the one or more dense rewards and the one or more sparse rewards are based on one or more target keyframes of the animated figure.

Optionally, in some embodiments, the control policy includes movement of the animated figure to achieve the one or more target keyframes, the one or more target keyframes including at least one of a position, a roll angle, a pitch angle, and a yaw angle of one or more joints or the base of the animated figure.

Optionally, in some embodiments, the control policy further includes one or more masking keyframes of unused or previous keyframes.

Optionally, in some embodiments, the control policy is determined based on a multi-critic reinforcement learning model, and wherein the multi-critic reinforcement learning model includes the one or more dense rewards and the one or more sparse rewards.

Optionally, in some embodiments, the multi-critic reinforcement learning model is trained based on the one or more dense rewards and the one or more sparse rewards.

In one embodiment, a non-transitory computer-readable media includes instructions to cause an animated figure to: receive one or more target keyframes; process, using a multi-input single-output transformer encoder, at least one or more sparse rewards and at least one or more dense rewards corresponding to the one or more target keyframes; and generate motion for the animated figure based on an output of the multi-input single-output transformer encoder, wherein the motion achieves the one or more target keyframes.

Optionally, in some embodiments, the one or more target keyframes include a target position, a target orientation, a target pose, a target joint configuration, a target velocity, a target timing, and a target acceleration of the animated figure.

Optionally, in some embodiments, a first keyframe of the one or more target keyframes corresponds to a self-goal keyframe including zero error and zero time to a goal.

Optionally, in some embodiments, the multi-input single-output transformer is created using a max-pooling layer.

Optionally, in some embodiments, the multi-input single-output transformer encoder receives as input one or more transformed target keyframes, wherein the one or more transformed target keyframes are transformed spatially and temporally.

Optionally, in some embodiments, wherein the multi-input single-output transformer encoder receives a goal error based on the one or more transformed target keyframes.

### BRIEF DESCRIPTION OF THE DRAWINGS

FIG. 1 illustrates a simplified schematic of a system for generating a movement based on keyframes using a control policy obtained by multi-critic reinforcement learning, according to embodiments herein.

FIG. 2 illustrates an example of a transformer-based architecture used by the control policy to encode a variable number of goals of the control policy, used by the system of FIG. 1.

FIG. 3 illustrates an example of different reward types that are learned by critics in the multi-critic reinforcement learning model, of the system of FIG. 1.

FIG. 4 illustrates an example method of training a control policy, with the system of FIG. 1.

FIG. 5 illustrates an example method of generating motion for an animated figure, according to the system of FIG. 1.

FIG. 6 illustrates an example of using keyframing to generate a movement for an animated figure, using the control policy and the system of FIG. 1.

FIG. 7 illustrates another example of using keyframing to generate a movement for an animated figure, with the system of FIG. 1.

FIG. 8 illustrates a functional block diagram of an animated figure operable or controllable according to the movement control policies based on keyframing according to the system of FIG. 1.

FIG. 9 illustrates a simplified block diagram of components of a computing system of the system of FIG. 1 according to embodiments herein.

### DETAILED DESCRIPTION

Embodiments herein provide for control over animated figure motion by incorporating multiple keyframes as input to a control policy, thereby enabling animated figures to generate diverse behaviors in reaching targets. Further enhancements according to embodiments herein include allowing partial or full targets, including base position, orientation, and joint postures (e.g., a roll angle, a pitch angle, and a yaw angle of one or more joints of the animated figure). In some embodiments, the methods and systems herein reward a control policy with different types of rewards. In some embodiments, the control policy is rewarded for meeting a target with sparse rewards (e.g., rewards that exist at specific times throughout an animated figure's motion). In some embodiments, a control policy is rewarded with dense rewards (e.g., rewards that exist through most or all of an animated figure's motion).

Embodiments disclosed herein generate movement control policies for an animated figure (e.g., bi-pedal figure, a four legged animated figure, a robot, a character in an animated film, show, video, display, or entertainment form of the sort) including smooth and natural movements that achieve specific character (e.g., animated figure) behavior from simple high-level inputs. The generation of the movement is done using control policies which take input keyframes (e.g., the simple high-level inputs) which specify, for example, a target position, a target pose, a kinematic pose of the character at particular points in time, and a general timing of when the animated figure is to hit the keyframe. As a result, a novice non-expert may use the control policy to generate a movement for an animated figure including desired target poses and positions (keyframes) with smooth and natural movement between the keyframes. Note that embodiments herein may refer to keyframes as goals.

Additionally, embodiments disclosed herein generate the movement control policies using a multi-critic reinforcement learning model framework trained on both sparse and dense rewards. For example, the sparse rewards may be active at specific times and reward the model when goal(s) (e.g., distance, target positional orientation, or joint angles or a combination thereof) are achieved. The dense rewards are active all times of an animation, rewarding the model based on regularization objectives or style objectives (e.g., smooth and/or natural movement). It should be understood that the dense rewards may encompass the instantaneous movement of the animated figure.

The control policy is trained based on a combination of the sparse rewards and the dense rewards. The rewards evaluate if the motion corresponding to the generated control policy is natural or not and generates a high reward if the motion corresponding to the control policy is good (e.g., hits the goals and is natural) and a low reward if it is bad (e.g., does not hit the goals or is not natural). The control policy is trained using reinforcement learning to achieve maximum rewards. The control policy and critics use an encoder that can take, as an input, a number of goals. In some instances, animal motion can additionally be used to train the model to achieve, for example, animal-like motions.

Embodiments herein overcome deficiencies found in current systems, as in current systems the combination use of dense and sparse rewards may be unbalanced as sparse rewards may be ignored due to sparse rewards being active only at specific times. Embodiments herein use a multi-critic reinforcement learning model to take into account and/or be trained by the combination of both dense and sparse rewards without discriminating against either reward. For example, each critic can be understood as an independently trained model (or neural network) that can learn to estimate value functions corresponding to a specific reward. The estimated value functions can provide advantage estimates. The advantage estimates are normalized independently for each critic/reward, thus balancing the effect of dense and sparse rewards.

Then the normalized advantages are combined (e.g., average, weighted average) to update the control policy at each training step. In some instances, each critic is weighted according to different values (e.g., 0 to 100) by the user according to an intended implementation of the respective dense and sparse rewards.

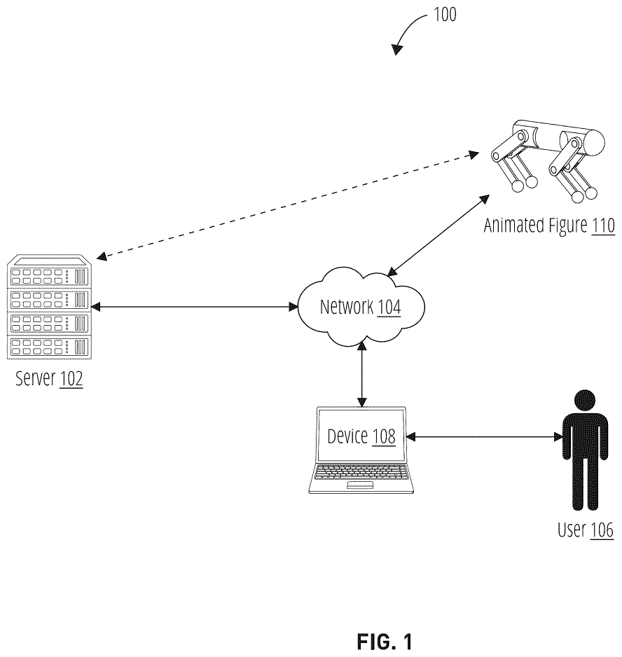

Turning to the figures, FIG. 1 illustrates a simplified schematic of a system 100 for generating a movement based on keyframes using a control policy obtained by multi-critic reinforcement learning, according to embodiments herein.

The system 100 for generating a movement based on keyframes using a multi-critic reinforcement learning model includes server 102, a network 104, a user 106, a device 108, and an animated FIG. 110, in some embodiments.

In some instances, the user 106 may input keyframes into a device 108. The keyframes include, for example, a target pose, position, orientation, joint angles, timing and/or velocity that the user 106 wants the animated FIG. 110 to achieve. The device 108 may forward the keyframes to the network 104. In some examples, the user 106 may initiate the control policy through the device 108. It should be understood that the device 108 may that the form of a user device (e.g., a phone), a computer, a control panel, a control joystick, or a combination thereof.

In some cases, the network 104 forwards the keyframes received from the device 108 to the server 102. The network 104 may also receive, from the server 102 a control policy and transmit to/encode the control policy onto the animated FIG. 110 to perform motion corresponding to the keyframes. In some embodiments, the network 104 generates the movement based on the keyframes using the control policy (model) stored at the server 102 and encodes the generated movement onto the animated FIG. 110. In some instances, the server 102 may directly communicate with the animated FIG. 110 without communication via the network 104.

The server 102 may receive keyframes from the network 104 inputted by the user 106 through the device 108. It should be understood that the server 102 stores and/or trains the multi-critic reinforcement learning model to generate the control policy. Additionally, the server 102 may generate the control policy that takes as input the keyframes and based on dense and sparse rewards discussed herein. Accordingly, the server 102 may transmit the generated control policy to the network 104 for the network 104 to encode onto the animated FIG. 110. In some examples, the server 102 may receive data from the network 104 and/or the animated FIG. 110 corresponding to motion previously performed by the animated FIG. 110 or constraints of the animated FIG. 110 to be used in the generation of future movements or control policies.

The animated FIG. 110 receives or is encoded with the generated movement or the control policy (from the network 104) and may perform the movement to achieve the keyframes inputted by the user 106. In some instances, the animated FIG. 110 may perform a portion of the movement thus simulating movement and transmit resulting movement to the network 104 for use in future movement or control policy generation. Additionally, the animated FIG. 110 may transmit to the network 104, data corresponding to the performance of motion corresponding to the control policy, or data corresponding to physical constraints of the animated FIG. 110.

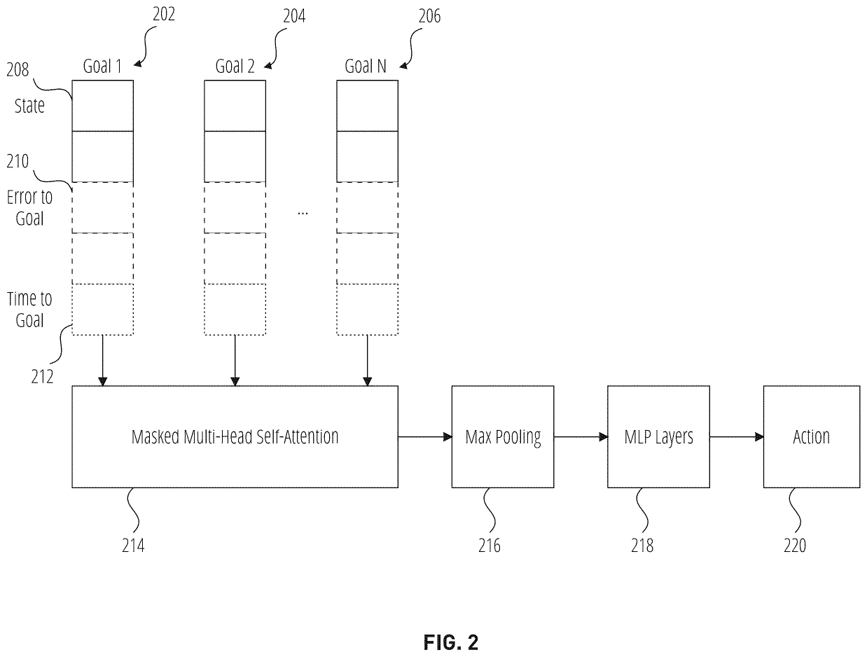

FIG. 2 illustrates an example of a transformer-based architecture used by the control policy to encode a variable number of goals of the control policy, used by the system of FIG. 1.

The transformer based architecture encodes a sequence of hitting goals (or not) as an input and outputs a single output (e.g., the action/signal to generate the next movement). For example, each goal may include a state 208, an error to goal 210 (e.g., how far off was the current state from the goal) and a time to goal 212 (e.g., how far off was the time from when the goal was to be achieved). Multiple goals may be taken into account by the transformer based architecture (e.g., first goal 202, second goal 204, . . . , Nth goal 206). The goals (e.g., first goal 202, second goal 204, . . . , Nth goal 206) may be passed to a masked multi-head self attention layer 214 and then passed to a max pooling function 216 which decides importance of the keyframes in generating the output. The output is passed to MLP layers 218 and accordingly the action 220 of the control policy is generated.

In some embodiments, a simulation may be performed to generate the movement using the control policy to calculate rewards based on the movement and outcome of the control policy. The simulated movement may further be used to train the policy or each critic of the multi-critic reinforcement learning model using a transformer based architecture to encode a variable number of goals that the control policy is to achieve with arbitrary time intervals. For example, if a short duration simulation of the control policy is completed, the simulation results may be used as further training data thus improving the control policy as a whole, based on the simulation results.

The transformer based architecture encodes a sequence of hitting goals (or not) as an input and outputs a single output (e.g., action/signal to generate the next movement). Each goal may be understood as, for example, achieving a keyframe target. The encoder of the transformer based architecture passes its output to a max pooling function which decides which part of the input is more important for generating the output and then the output is passed to multilayer perceptrons (MLP) layers to determine the motion to be performed in the next step by the control policy.

Additionally, the transformer framework may be utilized with modeling sequential data not only in the natural language processing but also in other areas including robotics. For example, the attention mechanism, serving as the core of transformer networks, models the correlation between each element of the input sequence and reweights them accordingly. To handle a variable number of keyframes, a transformer-based encoder is introduced to process the sequence of goals for both the policy and critics. However, unlike the current implementations of transformers in sequence-to-sequence tasks, the architecture functions in a sequence-to-token manner. This adaptation makes it suitable for autoregressive feedback control in robotic systems (or animated figures).

In some instances, each input token corresponds to a particular keyframe. At every time step t, each keyframe kⁱ is transformed spatially and temporally into an animated figure-centric view, resulting in a goal error

$$Δ {g}_{t}^{i}$$

and a calculated time to goal \hat{t}ⁱ−t. These are then concatenated with the animated figure state sₜ to form a single token. Additionally, a self-goal keyframe,

$${x}_{t}^{0} ,$$

is incorporated as the first token in the sequence. This token represents a state with zero error and zero time to goal, which ensures that the control system remains operational despite the absence of active goals or after achieving all goals. The transformer encoder receives the sequence of tokens

$${X}_{t} = ( {x}_{t}^{0} , … , {x}_{t}^{{n}_{i}} ) ,$$

$$where$$

$${x}_{t}^{0} = ( {s}_{t} , 0 , 0 ) ,$$

$$and$$

$${x}_{t}^{i} = ( {s}_{t} , Δ {g}_{t}^{i} , {\hat{t}}^{i} - t ) for i = 1 , … , {n}_{k} .$$

In scenarios where the number of active keyframes is less than the maximum capacity of the system, masking is applied to ignore the surplus tokens and focus on the relevant keyframes. Furthermore, masking may be applied to keyframes once their designated time is reached and surpassed by a few steps. This practice prevents past goals from inappropriately influencing the long-term behavior of the policy. The output from the transformer encoder is then forwarded to a max-pooling layer, which condenses the encoded goal features for delivery to the subsequent multilayer perceptrons (MLP). By leveraging transformer's ability to handle sequences of varying lengths, the transformer based architecture discussed herein can effectively integrate multiple and arbitrary numbers of goals into the control process.

It should be understood that the use of keyframing and the multi-critic reinforcement learning model to generate a control policy may be used when generating animations/simulations or may be used with robots (e.g., a four legged robot) and/or animatronics corresponding to the animated figure. Additionally, the control policy may be deployed on a physical robot or simulated as a digital character in, for example, a film, a show, or other art forms of the sort.

An advantage of using a transformer-based encoder is that it enables the control policy to incorporate multiple and a varying number of goals as input(s). If the goals are temporally close to each other, awareness of future goals influences the robot's motion to achieve all of them more accurately. This is particularly important when keyframes are temporally close, resulting in higher accuracy gains in fast and dynamic movements, compared to slower ones.

In some embodiments, the movement control policies are generated for quadruped animated figures with twelve degrees of freedom (DoF). At the start of each movement, the animated figure is either set to a default state or initialized according to a posture and height sampled from the dataset. A learning curriculum may be incorporated to train the control policy, beginning with keyframes entirely sourced from reference data and progressively increasing the proportion of randomly generated keyframes, with time intervals, position targets, and yaw angles each sampled from a predetermined range.

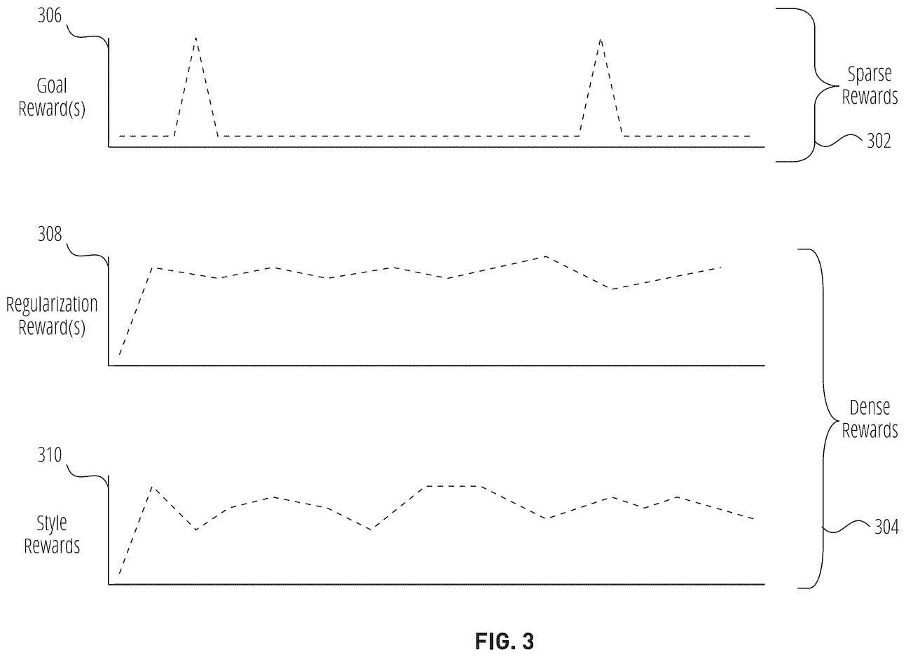

FIG. 3 illustrates an example of different reward types that are learned by critics in the multi-critic reinforcement learning model, of the system of FIG. 1.

As discussed herein, the multi-critic reinforcement learning model may include various critics learning value functions for various rewards including a goal reward 306, a regularization reward 308, a style reward 310 or a combination thereof. The goal reward 306 may be active at specific times as a goal is hit at specific times by the motion corresponding to the control policy. As a result, the goal reward 306 is understood as a sparse reward 302 that is active at specific times.

The regularization reward 308 and the style reward 310 are active at all times as the motion corresponding to the control policy may be rewarded for having correct/strong regularization or style throughout the entire motion of the control policy. As a result, the regularization reward 308 and the style reward 310 may be understood as a dense reward 304 that is active at all times.

Note that the goal reward 306, the regularization reward 308, and the style reward 310 are used by independent neural networks (critics) that are a part of the multi-critic reinforcement learning model to estimate the value function for each reward independently.

In some cases, a lightweight sequence-to-token module may be introduced and used autoregressively within a feedback control loop of the multi-critic reinforcement learning model. For example, the lightweight sequence-to-token module may be computationally less expensive compared to non-light weight sequence to sequence module. Embodiments herein successfully guide the animated figure to meet multiple keyframes at, in some cases, various times, for both position and posture targets. Furthermore, the multi-critic approach discussed herein showcases better convergence with less hyperparameter tuning compared to the conventional single-critic methods currently implemented.

Additionally, in some embodiments, synthesizing naturalistic behavior from motion datasets while fulfilling spatial or temporal conditions has been implemented. For example, in some current procedures the generation of natural motion between keyframes has focused on the kinematic properties of characters and thus cannot be directly applied to physics-based characters or animated figures, whose dynamic interactions with the environment may need consideration of both kinematics and dynamics. However, according to some embodiments, kinematic motion generation may be combined with physically controlled robots to achieve natural behavior on hardware. Some such embodiments may focus on controlling characters in physically simulated environments, incorporating motion datasets as demonstrations. In some cases, adversarial motion priors (AMP) have been considered to provide a flexible way to encourage the policy to have natural, expert-like behavior by connecting generative adversarial networks (GAN) with RL given an offline motion dataset. Further, embodiments herein may incorporate an AMP-based style objective to encourage naturalistic motion for the policy and further extend it to infilling keyframes for animated figures.

In some examples, reinforcement learning (RL) algorithms typically employ an actor-critic paradigm, where the actor decides the action to take, and the critic evaluates the action by estimating the value function. In some embodiments, to effectively manage a complex mixture of temporally dense and sparse rewards, embodiments herein introduce a multi-critic (MuC) RL framework. The multi-critic RL framework involves training a set of critic networks

$${\{ {V}_{{ϕ}_{i}} \}}_{i = 0}^{n}$$

to learn distinct value functions associated with different reward groups

$${\{ {r}_{i} \}}_{i = 0}^{n} .$$

Further embodiments herein introduce the multi-critic method to the context of dense and sparse reward combination. In some examples, each reward group contains either exclusively dense or sparse rewards. This division is essential for effectively managing the distinct temporal characteristics of each reward type and facilitates value estimation.

Additionally, the multi-critic RL framework may be integrated to Proximal Policy Optimization (PPO). Particularly, each value network V_{φ}_{ᵢ}(⋅) is trained independently for a specific reward group rᵢ with temporal difference loss:

$$L ( {ϕ}_{i} ) = {\hat{𝔼}}_{t} [ {‖ {r}_{i , t} + γ {V}_{{ϕ}_{i}} ( {s}_{t + 1} ) - {V}_{{ϕ}_{i}} ( {s}_{t} ) ‖}^{2} ] ,$$

where [symbol] is the empirical average and γ is the discount factor. The value functions calculated by each critic are used to individually estimate the advantage

$${\{ {\hat{A}}_{i} \}}_{i = 0}^{n}$$

for each reward group. Subsequently, these advantages are synthesized into a policy improvement step by calculating the multi-critic advantage as a weighted sum of the normalized advantages from each reward group:

$${\hat{A}}_{MuC} = {\sum }_{i = 0}^{n} {ω}_{i} \cdot \frac{{\hat{A}}_{i} - {μ}_{{\hat{A}}_{i}}}{{σ}_{{\hat{A}}_{i}}} ,$$

where μ_{Â}_{ᵢ} and σ_{Â}_{ᵢ} are the batch mean and standard deviation of the advantage from group i. Similar to PPO, the surrogate loss for policy gradient is clipped, resulting as:

$${L}^{CLIP - MuC} ( θ ) = {\hat{𝔼}}_{t} [ min ( {α}_{t} ( θ ) {\hat{A}}_{MuC , t} , clip ( {α}_{t} ( θ ) , 1 - ϵ , 1 + ϵ ) {\hat{A}}_{MuC , t} ) ] ,$$

where αₜ(θ) and ϵ respectively denote the probability ratio and the clipping hyperparameter. This formulation integrates feedback from both dense and sparse rewards into the policy update, facilitating a balanced and effective learning process.

In some cases, policy parameters θ and parameters of each critic, φᵢ may be initialized. A policy π_{θ} may be rolled out to fill the buffer. An estimate Âᵢ may be made for each rᵢ, and Â_{MuC} may be computed. Additionally, the policy may be updated and each critic may be updated.

In some examples, assigning distinct critics for dense and sparse rewards helps achieve each set of objectives more effectively while reducing the reliance on extensive hyperparameter tuning. Consider an example with an episode length of T involving two types of rewards: a temporally dense reward r_{d} that is active at every step and a temporally sparse reward rₛ that is active at the final step of an episode:

$${r}_{s , t} = \{ \begin{matrix}{\hat{r}}_{s} , & t = T \\ 0 , & otherwise .\end{matrix}$$

In the conventional single-critic RL, the total reward of each time step t is typically computed as a linear combination of different reward terms rₜ=wₛr_{s,t}+w_{d}r_{d,t}. The value in this scenario is:

$$V ( {s}_{t} ) = 𝔼 [ {ω}_{s} {γ}^{( T - t )} {\hat{r}}_{s} + {ω}_{d} {\sum }_{k = t}^{T} {γ}^{k} {r}_{d , k} ] .$$

The reward sparsity ratio may be defined as a number of dense reward steps per sparse reward horizon, which is here equal to T. The second term in equation above includes a summation over T-t individual reward terms, whereas the first term includes a single component. This highlights the impact of different reward sparsities on the learning process, suggesting that the weight of reward groups need to be adjusted for different sparsity ratios to achieve a proper balance. This challenge is amplified when the sparsity ratio changes between episodes, for example, when keyframe timings are randomly sampled within a range. These variations can complicate the hyperparameter tuning process and hinder the efficacy of the learning algorithm.

In the multi-critic approach according to embodiments herein, the advantage for each reward group is normalized independently, ensuring that a fixed weight ratio for the advantages is adequate to maintain the desired balance, regardless of variations in the sparsity ratio. As a result, embodiments herein may decouple a reward frequency and a magnitude from the learning process, enabling more effective policy optimization and reducing the effort for manual hyperparameter tuning.

In some instances, light detection and ranging (LiDAR) data may be used by the multi-critic reinforcement learning model (policy) to generate the movement. For example, the LiDAR data may indicate the position of the animated figure with respect to its environment as to not exceed environmental constraints. Additionally, the LiDAR data may indicate the animated figure's pose based on the position and orientation in the environment and as a result being able to determine the error to goal as input to the control policy and to determine whether the multi-critic reinforcement learning model is to be rewarded (or not) for producing motion where the animated figure is in a correct pose.

In some embodiments, tokens of past or unused keyframes are masked to prevent them from negatively affecting the long-term behavior of the policy.

In some implementations, a user or an artist (e.g., puppeteer) may animate a complete movement sequence corresponding to a dance, a song, or intended emotion, to be performed by an animated figure through the use of keyframes thus producing a control policy for the animated figure. Then, the user may initialize the control policy thus starting the motion of the animated figure. In some other implementations, the user or artist may set a time when the control policy is to be initiated and performed by the animated figure. In some examples, a joystick or control panel may be used to initialize the control policy or initiate an algorithm that determines which goals (e.g., keyframes) the animated figure is to achieve.

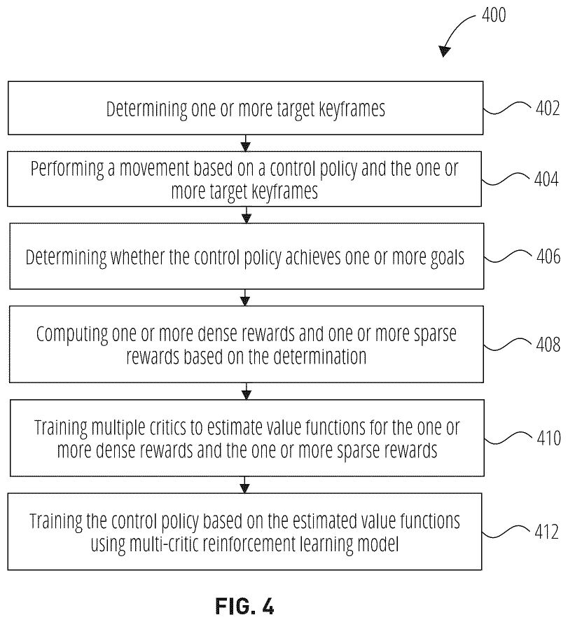

FIG. 4 illustrates an example method 400 of training a control policy, with the system of FIG. 1.

The illustrated method 400 includes determining one or more target keyframes. For example, a user may input one or more keyframes that are to be achieved by the animated figure.

The illustrated method 400 includes performing 402 a movement based on a control policy and the one or more target keyframes. For example, a baseline control policy or an initial control policy may be performed initially as to determine whether the control policy achieves or does not achieve various critics and/or the one or more target keyframes.

The method 400 further includes performing a movement based on a control policy and the one or more target keyframes. For example, the movement may be performed by the animated figure based on a previous (less-trained) control policy.

The method 400 further includes determining 406 whether the control policy achieves one or more goals. For example, a goal may be understood as being achieved if the movement performed based on the control policy hits a certain position, pose, angle, etc.

The method 400 further includes computing 408 one or more dense rewards and one or more sparse rewards based on the determination. For example, the multi-critic reinforcement learning model may compute a reward as the animated figure is performing the control policy and/or may predict a future reward and give an approximation of a reward to further train the multi-critic reinforcement learning model for future generation of control policy.

The method 400 further includes training 410 multiple critics to estimate value functions for the one or more dense rewards and the one or more sparse rewards. For example, a goal critic may be understood as a sparse reward critic while a regularization critic and a style critic are understood as dense reward critics. The goal critic may include whether the animated figure achieves the keyframe, whether a correct position was achieved, whether desired joint angles were achieved, and whether a desired velocity was hit at a set time. It should be understood that hitting a goal may also encompass staying within a desired range of that goal (e.g., stay within the bounds of set velocities or set joint angles). Goal critics are defined with a temporally sparse kernel Φⁱ(x):

$${Φ}^{i} ( x ) = \{ \begin{matrix}x , & t - {\hat{t}}^{i} \\ 0 , & otherwise ,\end{matrix}$$

and activated when the corresponding timestep for that goal \hat{t}ⁱ is reached in the episode. The detailed reward terms are provided below. The values of sigma and/or delta may vary for different animated figures/different target ranges.

Goal Critic Terms

| | |
|---|---|
| Goal position | Φⁱ(K(p − \hat{p}ⁱ, 0.2, 0)) |
| Goal roll | Φⁱ(K(φ − \hat{φ}ⁱ, 0.1, 0)) |
| Goal pitch | Φⁱ(K(ζ − \hat{ζ}ⁱ, 0.1, 0)) |
| Goal yaw | Φⁱ(K(ψ − \hat{ψ}ⁱ, 0.3, 0)) |
| Goal posture | Φⁱ(K(∥θⱼ − \hat{θ}ⱼⁱ∥, 0.2, 0)) |

Here, [symbol] is an exponential kernel function where α and δ are the sensitivity and tolerance of the kernel function, respectively.

$$( x , σ , δ ) = exp ( - {( \frac{max ( 0 , ‖ x ‖ - δ )}{σ} )}^{2} )$$

The regularization critic may include the regularization ofthe motion corresponding to the control policy such as staying within desired acceleration bounds, not exceeding joint limits of the animated figure, not exceeding velocity limits of the animated figure, not performing jerky unnatural motions, not performing excessive unnatural torquey movement, not exceeding acceleration value(s). Further, the regularization critic may include a jerking motion value and a torque value that is not to be exceeded. Regularization critics are designed to provide a smooth output of the policy and consist of several terms provided below.

Regularization Critic Terms

| | |
|---|---|
| Action Rate | K(\dot{a}, 8.0, 0) |
| Base horizontal acceleration | K(\ddot{p}_{xy}, 8.0, 0) |
| Joint acceleration | K(\ddot{θ}ⱼ, 150.0, 10.0) |
| Joint soft limits | K(max(θⱼ − θ_{j, max}, θ_{j, min} − θⱼ, 0), 0.1, 0) |

The style critic (a discriminatory critic) may include estimating a discriminator reward corresponding to how natural and smooth the movement is, a reward for natural motion and training data including reference animal motion or animated motion that the motion corresponding to the control policy may be compared to. The style critic is defined based on the discriminator output of the latest state transition of the robot (sₜ₋₁, sₜ).

$${r}_{style} = max ( 1 - 0.25 {( ( {s}_{t - 1} , {s}_{t} ) - 1 )}^{2} , 0 )$$

In some cases, the multiple critics (goal critic, regularization critic and style critic) may be weighted as to produce a natural and smooth control policy. For example, if the control policy includes movement that is hitting the targets but does not look natural, the style or regularization critics may be weighted more heavily than another critic. If the control policy is producing movement that looks natural but is not hitting the intended targets, the goal critic may be weighted more heavily than another critic. In some other cases, a single critic may be used to train the reinforcement learning model, however the training of the model may take longer than without a multi-critic approach, as it might be difficult to learn the sparse rewards. In some embodiments, no normalization may be used, such as when using a single critic to train the model.

The method 400 further includes training 412 the control policy based on the estimated value functions using the multi-critic reinforcement learning model. For example, the multi-critic reinforcement learning model may train the control policy based on the rewards corresponding to whether the control policy achieved the critics and/or goals.

In some examples to train the control policy, at the start of each movement, the animated figure is either set to a default state or initialized according to a posture and height sampled from the dataset with reference state initialization (RSI). RSI plays a crucial role in capturing and learning a specific style of motion. Keyframes are inputted or derived either randomly or directly from a reference data trajectory. Then, a learning curriculum is incorporated, beginning with keyframes entirely sourced from reference data and progressively increasing the proportion of randomly generated keyframes. To generate random keyframes, a time interval is selected for each goal within a predetermined range. Subsequently, the distance and direction of the target position relative to the previous goal (or the initial position for the first goal) are sampled based on a specified range. The yaw angle is also chosen from a set range and adjusted relative to the previous goal. The animated figure's full posture is sampled from the dataset to ensure the target posture is feasible. The roll, pitch, and height of the keyframe are aligned with the corresponding attributes of the target posture frame. The meticulous sampling of target keyframes may be performed to ensure their feasibility and preventing them from impeding effective policy learning.

The control policy is trained to handle a maximum number of keyframes, randomly selecting the actual number of keyframes for each performance of the control policy. To avoid negative impacts on training, unused goals are masked when input into the transformer encoder. For stability, the control policy does not terminate immediately after the last goal is reached. Instead, it terminates a certain one period of time later (e.g., one second later). In some instances, the training setup for a full keyframe comprising time, position, roll, pitch, yaw, and posture targets with up to, for example, five maximum keyframes may be lengthy (e.g., 15-20 hours).

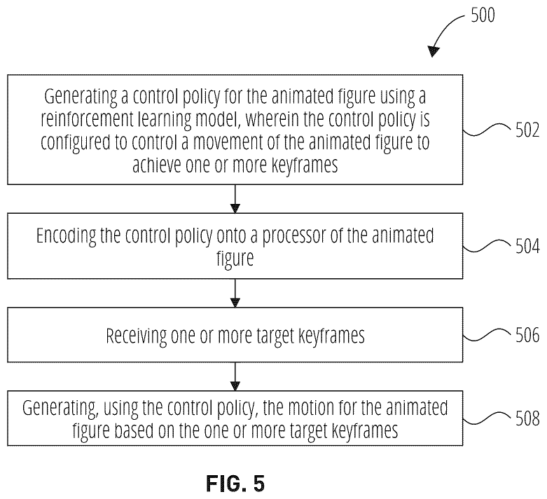

FIG. 5 illustrates an example method 500 of generating motion for an animated figure, according to the system of FIG. 1.

The illustrated method 500 includes generating 502 a control policy for the animated figure using a learning model, wherein the control policy controls a movement of the animated figure to achieve one or more keyframes. For example, the multi-critic reinforcement learning model may be trained with one or more dense rewards and one or more sparse rewards estimated based on if the control policy achieves certain critics and/or goals. The critics/goals may include various critics such as a goal critic, a regularization critic, and a style critic that are rewarded (with the dense or sparse rewards) when hit. In some instances, the dense rewards and the sparse rewards may be weighted by the model or according to user input.

The method 500 further includes encoding 504 the control policy onto a processor of the animated figure. For example, the control policy may be transmitted to the animated figure to be performed by the animated figure. In some cases, data corresponding to a performed control policy may be used in the generation of future control policies or in the further training of the multi-critic reinforcement learning model. The control policy effectively reaches keyframes at the designated times. Given keyframes including position goals, the control policy reaches its targets with notable precision even when having a different number of differing keyframes. Embodiments herein additionally offer control over target reaching time and can generate diverse behaviors for the same targets by specifying different time profiles. Further, embodiments herein support full posture targets along with position and orientation goals while maintaining natural motion.

The method 500 further includes receiving 506 one or more target keyframes. For example, the target keyframes may be receiving from a user including one or more of a target position, a target pose, a target velocity, a target timing, a target acceleration that the user wants the animated figure to achieve. Note that target keyframes are received from a user.

The method 500 further includes generating 508, using the control policy, the motion for the animated figure based on the one or more target keyframes. For example, the animated figure may perform motion corresponding to the control policy to achieve the one or more target keyframes inputted by the user. Note that the motion is natural and smooth without rigid or choppy movement.

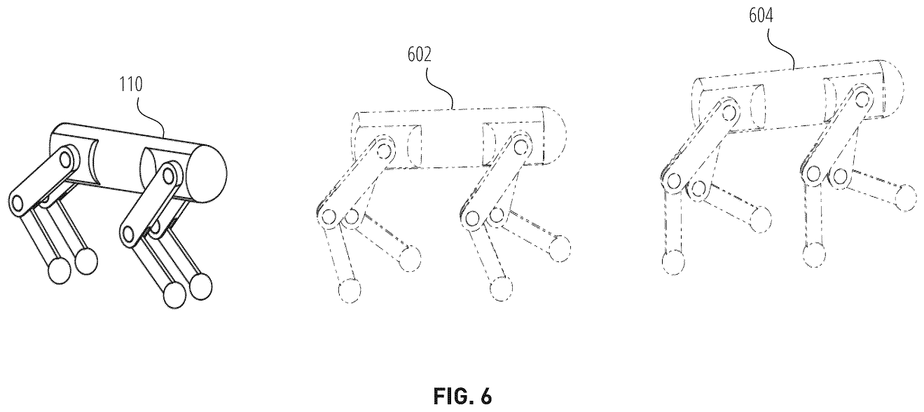

FIG. 6 illustrates an example of using keyframing to generate a movement for an animated figure, using the control policy and the system of FIG. 1.

In some examples a user may input and/or set various keyframes (e.g., a first keyframe 602 and a second keyframe 604) for the animated FIG. 110 to achieve. The movement may then be generated for the animated FIG. 110 by the system 100 with smooth and natural motion achieving the first keyframe 602 and the second keyframe 604. At each time, the motion of the animated figure is transferred back to the system 100 to generate the next movement. In such examples, the motion corresponding to the first keyframe 602 and the second keyframe 604 includes the animated FIG. 110 walking forward from its initial position to the first keyframe 602 and further to the second keyframe 604. It should be understood that the control policy generates motion from the initial position of the animated FIG. 110 to the first keyframe 602 and further to the second keyframe 604 which is infilled by the multi-critic reinforcement learning model (control policy) with smooth and natural motion.

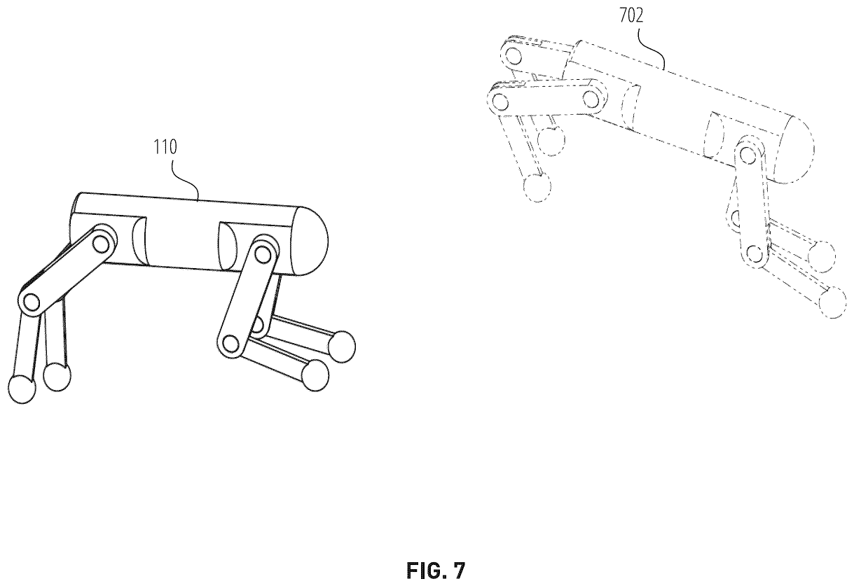

FIG. 7 illustrates another example of using keyframing to generate a movement for an animated figure, with the system of FIG. 1.

In some instances, the keyframe inputted by the user may include different poses or actions for the animated FIG. 110 to perform. For example, the keyframe 702 may include the animated FIG. 110 jumping in the air including certain joint angles and poses. The trained multi-critic reinforcement learning model (control policy), based on the keyframe 702 generates a motion including natural movement to achieve the jumping keyframe.

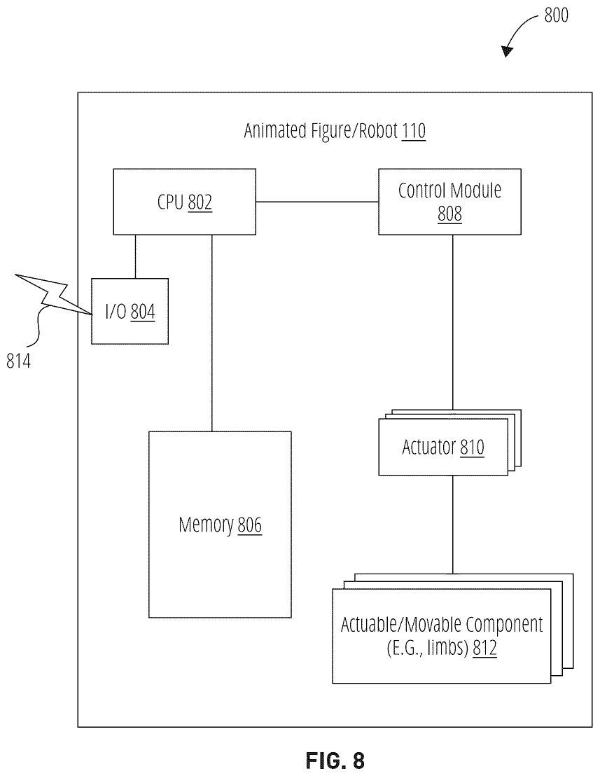

FIG. 8 illustrates a functional block diagram of a portion of the system of FIG. 1. For example, generated animation based on the movement control policies could provide movements and emotions of a character's story or intended effect of an attraction. The movements and emotions (and artistic characteristics) are loaded into an already existing animated FIG. 110 of a system 800 as shown in a wired or wireless manner with arrows 814. After loading, the animated figure becomes an actor with the capability to perform a role, according to the control policies, which tells a story through motion and emotion. This control policies may be a script, instructions, or mode.

The animated figure may take a wide variety of forms to practice the generated animation. Generally, the animated figure will include a pelvis, a torso, and a head, but these are not required. Further, the animated figure will include a plurality of actuators 810 (or drivers) selectively operated by a control module 808 to actuate or drive one or more movable components 812 such as two or more limbs with (or without) feet, two (or more) arms with (or without) hands, and so on. Examples generally encompasses animations for a two-legged or four-legged animated figure, but this is not a limitation as the concepts are equally applicable to other movable components of an animated figure.

The animated figure includes a processor 802 managing operations of I/O 804 devices, which are used at least to receive communications such as from a design station, which may be an ordinary PC workstation, laptop, or the like using software tools described in the following paragraphs. Particularly, the animated FIG. 110 also includes memory 806 or data storage devices for storing the animation received from, for example, a server or computer where the animation is generated and/or stored.

The processor 802 runs software and/or executes code/instructions (e.g., in memory 806) to provide the functionality of a control module 808. The control module 808 may be configured to include one or more AI components and to otherwise adapt to current conditions for the animated figure. For example, the control module 808 may operate to determine a present mood of the animated figure (such as afraid, sad, or happy based on input from sensors or other I/O 804 components) and or the state/configuration of the animated figure (such as position, orientation, joint configurations), and the control module 808 may then control the animated figure (e.g., via control signals to the actuators 810) based on the motions in the generated animation.

Motion blending of control module 808 may be configured to generate reasonable transition actions between the actions (or positions) defined in the generated animations so that every possible movement/action of the animated figure does not have to be predefined. The AI of the control module 808 also acts to keep the animated figure within the nature of the character even when not animated (not performing a movement), and this may include staying “alive” or in the moment (e.g., by retaining the expected body language). As can be seen from FIG. 8, the animated figure is controlled using a set of actions as defined by the generated animation to perform a gesture or movement in a manner that is defined for a particular character, which provokes emotion and/or belief of life in a human observer of the animated figure.

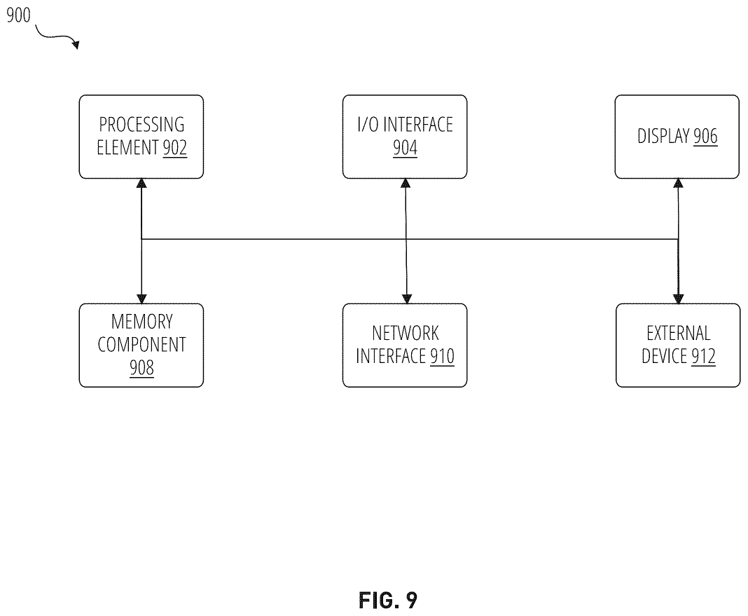

FIG. 9 is a simplified block diagram of components of a computing system 900 of the system 100, such as the server 102, the device 108 etc. For example, the processing element 902 and the memory component 908 may be located at one or in several computing systems 900. This disclosure contemplates any suitable number of such computing systems 900. For example, the server 102 may be a desktop computing system, a mainframe, a blade, a mesh of computing systems 900, a laptop or notebook computing system 900, a tablet computing system 900, an embedded computing system 900, a system-on-chip, a single-board computing system 900, or a combination of two or more of these. Where appropriate, a computing system 900 may include one or more computing systems 900; be unitary or distributed; span multiple locations; span multiple machines; span multiple data centers; or reside in a cloud, which may include one or more cloud components in one or more networks. A computing system 900 may include one or more processing elements 902, an input/output I/O interface 904, one or more external devices 912, one or more memory components 908, and a network interface 910. Each of the various components may be in communication with one another through one or more buses or communication networks, such as wired or wireless networks, e.g., the network 104. The components in FIG. 9 are exemplary only. In various examples, the computing system 900 may include additional components and/or functionality not shown in FIG. 9.

The processing element 902 may be any type of electronic device capable of processing, receiving, and/or transmitting instructions. For example, the processing element 902 may be a central processing unit, microprocessor, processor, or microcontroller. Additionally, it should be noted that some components of the computing system 900 may be controlled by a first processing element 902 and other components may be controlled by a second processing element 902, where the first and second processing elements may or may not be in communication with each other.

The I/O interface 904 allows a user to enter data in to computing system 900, as well as provides an input/output for the computing system 900 to communicate with other devices or services. The I/O interface 904 can include one or more input buttons, touch pads, touch screens, and so on.

The external device 912 are one or more devices that can be used to provide various inputs to the computing systems 600, e.g., mouse, microphone, keyboard, trackpad, sensing element (e.g., a thermistor, humidity sensor, light detector, etc.). The external devices 912 may be local or remote and may vary as desired. In some examples, the external devices 912 may also include one or more additional sensors.

The memory components 908 are used by the computing system 900 to store instructions for the processing element 902, as well as store data. The memory components 908 may be, for example, magneto-optical storage, read-only memory, random access memory, erasable programmable memory, flash memory, or a combination of one or more types of memory components.

The network interface 910 provides communication to and from the computing system 900 to other devices. The network interface 910 includes one or more communication protocols, such as, but not limited to Wi-Fi, Ethernet, Bluetooth, etc. The network interface 910 may also include one or more hardwired components, such as a Universal Serial Bus (USB) cable, or the like. The configuration of the network interface 910 depends on the types of communication desired and may be modified to communicate via Wi-Fi, Bluetooth, etc.

The display 906 provides a visual output for the computing system 900 and may be varied as needed based on the device. The display 906 may be configured to provide visual feedback to the user 106 and may include a liquid crystal display screen, light emitting diode screen, plasma screen, or the like. In some examples, the display 906 may be configured to act as an input element for the user 106 through touch feedback or the like.

The computing system 900 may be include a physical device or separate physical devices including components to read and execute instructions from a machine-readable or computer-readable medium (e.g., a non-transitory machine-readable storage medium).

The description of certain embodiments included herein is merely exemplary in nature and is in no way intended to limit the scope of the disclosure or its applications or uses. In the included detailed description of embodiments of the present systems and methods, reference is made to the accompanying drawings which form a part hereof, and which are shown by way of illustration specific to embodiments in which the described systems and methods may be practiced. These embodiments are described in sufficient detail to enable those skilled in the art to practice presently disclosed systems and methods, and it is to be understood that other embodiments may be utilized, and that structural and logical changes may be made without departing from the spirit and scope of the disclosure. Moreover, for the purpose of clarity, detailed descriptions of certain features will not be discussed when they would be apparent to those with skill in the art so as not to obscure the description of embodiments of the disclosure. The included detailed description is therefore not to be taken in a limiting sense, and the scope of the disclosure is defined only by the appended claims.

From the foregoing it will be appreciated that, although specific embodiments of the invention have been described herein for purposes of illustration, various modifications may be made without deviating from the spirit and scope of the invention.

The particulars shown herein are by way of example and for purposes of illustrative discussion of the preferred embodiments of the present invention only and are presented in the cause of providing what is believed to be the most useful and readily understood description of the principles and conceptual aspects of various embodiments of the invention. In this regard, no attempt is made to show structural details of the invention in more detail than is necessary for the fundamental understanding of the invention, the description taken with the drawings and/or examples making apparent to those skilled in the art how the several forms of the invention may be embodied in practice.

As used herein and unless otherwise indicated, the terms “a” and “an” are taken to mean “one”, “at least one” or “one or more”. Unless otherwise required by context, singular terms used herein shall include pluralities and plural terms shall include the singular.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application.

Of course, it is to be appreciated that any one of the examples, embodiments or processes described herein may be combined with one or more other examples, embodiments and/or processes or be separated and/or performed amongst separate devices or device portions in accordance with the present systems, devices and methods.

Finally, the above discussion is intended to be merely illustrative of the present system and should not be construed as limiting the appended claims to any particular embodiment or group of embodiments. Thus, while the present system has been described in particular detail with reference to exemplary embodiments, it should also be appreciated that numerous modifications and alternative embodiments may be devised by those having ordinary skill in the art without departing from the broader and intended spirit and scope of the present system as set forth in the claims that follow. Accordingly, the specification and drawings are to be regarded in an illustrative manner and are not intended to limit the scope of the appended claims.

1. A method of generating motion for an animated figure comprising:
generating a control policy for the animated figure using a reinforcement learning model, wherein the control policy is configured to control a movement of the animated figure to achieve one or more keyframes;
encoding the control policy onto a processor of the animated figure;
receiving one or more target keyframes; and
generating, using the control policy, the motion for the animated figure based on the one or more target keyframes.

2. The method of claim 1, wherein the reinforcement learning model comprises a multi-critic reinforcement learning model.

3. The method of claim 2, wherein the multi-critic reinforcement learning model comprises one or more dense rewards and one or more sparse rewards.

4. The method of claim 3, further comprising:
training the multi-critic reinforcement learning model using the one or more dense rewards and the one or more sparse rewards, wherein the one or more dense rewards are normalized independently from the one or more sparse rewards.

5. The method of claim 3, wherein the one or more dense rewards correspond to instantaneous movement of the control policy.

6. The method of claim 3, wherein the one or more sparse rewards correspond to whether the generated motion correctly corresponds to the one or more target keyframes.

7. The method of claim 1, wherein the reinforcement learning model comprises one or more regularization critics and wherein the one or more regularization critics comprise one or more of: an acceleration value, an animated figure joint limit value, an animated figure velocity limit value, a jerking motion value, and a torque value.

8. The method of claim 1, wherein the reinforcement learning model comprises one or more style critics and wherein the one or more style critics comprise one or more of: a discriminator reward estimate, a natural motion reward, and reference motion corresponding to animal motions, human motions or animated motions.

9. The method of claim 1, wherein generating the control policy is further based on using a multi-input single-output transformer encoder.

10. An animated figure comprising:
at least one actuator:
a processing element;
a memory component, wherein the memory component stores a control policy trained based on one or more sparse rewards and one or more dense rewards, wherein the one or more dense rewards and the one or more sparse rewards are based on one or more target keyframes of the animated figure.

11. The animated figure of claim 10, wherein the control policy comprises movement of the animated figure to achieve the one or more target keyframes, the one or more target keyframes comprising at least one of a position, a roll angle, a pitch angle, and a yaw angle of one or more joints or the base of the animated figure.

12. The animated figure of claim 10, wherein the control policy further comprises one or more masking keyframes of unused or previous keyframes.

13. The animated figure of claim 10, wherein the control policy is determined based on a multi-critic reinforcement learning model, and wherein the multi-critic reinforcement learning model comprises the one or more dense rewards and the one or more sparse rewards.

14. The animated figure of claim 13, wherein the multi-critic reinforcement learning model is trained based on the one or more dense rewards and the one or more sparse rewards.

15. A non-transitory computer-readable media comprising instructions to cause an animated figure to:
receive one or more target keyframes;
process, using a multi-input single-output transformer encoder, at least one or more sparse rewards and at least one or more dense rewards corresponding to the one or more target keyframes; and
generate motion for the animated figure based on an output of the multi-input single-output transformer encoder, wherein the motion achieves the one or more target keyframes.

16. The non-transitory computer-readable media of claim 15, wherein the one or more target keyframes comprise a target position, a target orientation, a target pose, a target joint configuration, a target velocity, a target timing, and a target acceleration of the animated figure.

17. The non-transitory computer-readable media of claim 15, wherein a first keyframe of the one or more target keyframes corresponds to a self-goal keyframe comprising zero error and zero time to a goal.

18. The non-transitory computer-readable media of claim 15, wherein the multi-input single-output transformer is created using a max-pooling layer.

19. The non-transitory computer-readable media of claim 15, wherein the multi-input single-output transformer encoder receives as input one or more transformed target keyframes, wherein the one or more transformed target keyframes are transformed spatially and temporally.

20. The non-transitory computer-readable media of claim 19, wherein the multi-input single-output transformer encoder receives a goal error based on the one or more transformed target keyframes.
